(19) United States
(12) Patent Application Publication
(10) Pub. No.: US 2026/0106181 A1
(43) Pub. Date: Apr. 16, 2026

(54) MEMBRANE-ELECTRODE ASSEMBLY TO PREVENT REVERSE VOLTAGE OF FUELCELL

(71) Applicants: Hyundai Motor Company, Seoul (KR); Kia Corporation, Seoul (KR)

(72) Inventors: Je Hyeon Yeon, Hwaseong-si (KR); Seong Min Yuk, Hwaseong-si (KR)

(21) Appl. No.: 19/043,793

(22) Filed: Feb. 3, 2025

(30) Foreign Application Priority Data
Oct. 15, 2024 (KR) 10-2024-0140101

(51) Int. Cl. H01M 4/92; H01M 4/86

(52) U.S. Cl. CPC H01M 4/926; H01M 4/8621; H01M 2004/8689

(57) ABSTRACT

A membrane-electrode assembly for preventing reverse voltage of a fuel cell can include an electrolyte membrane positioned between a cathode and an anode, where the cathode and the anode each include a supported catalyst with a metal catalyst held on a support, and where a ratio MC_{L}/R between metal catalyst loading MC_{L} in the anode and a supported metal catalyst ratio R is 0.125 to 0.3. Such membrane-electrode assembly can prevent a flooding phenomenon that may occur in cold start driving or rapid acceleration driving by appropriately controlling physical property factors related to the anode of a fuel cell. Accordingly, such membrane-electrode assembly can suppress carbon corrosion at the anode and improve durability.

### CROSS-REFERENCE TO RELATED APPLICATIONS

The present application claims priority to Korean Patent Applications No. 10-2024-0140101, filed on Oct. 15, 2024, the entire contents of which are incorporated herein for all purposes by this reference.

### TECHNICAL FIELD

The present disclosure relates to a membrane-electrode assembly for preventing reverse voltage of a fuel cell.

### BACKGROUND

A fuel cell is a power generation system that generates electrical energy by electrochemically reacting hydrogen and oxygen. Fuel cells are, in accordance with the kinds of electrolytes that are used, classified into a phosphoric acid fuel cell, a molten carbonate fuel cell, a solid oxide fuel cell, and polymer electrolyte membrane fuel cell, an alkaline fuel cell, or other electrolyte fuel cells as known in the art. These fuel cells are operated fundamentally by the same principle, but they are different in the kinds of fuel cell, operating temperature, catalyst, electrolyte, etc.

Fuel cells are used in a stack type assembled by stacking tens of to hundreds of unit cells to satisfy the level of required power. The unit cells include a bipolar plate, a gas diffusion layer (GDL), electrodes (anode and cathode), and an electrolyte membrane such as a polymer electrolyte membrane (proton exchange membrane), and the assembly formed by attaching the two electrodes to a polymer electrolyte membrane is called a polymer electrolyte Membrane Electrode Assembly (MEA). The configuration and performance of the MEA can be considered the core of fuel cells.

In an electrochemical reaction in fuel cells, hydrogen supplied to the anode is separated into protons and electrons by a Hydrogen Oxidation Reaction (HOR) and then, the protons move to the cathode through a membrane and the electrons move to the cathode through an external circuit. The protons and electrons react with oxygen supplied from the outside by an Oxygen Reduction Reaction (ORR) at the cathode, and generate electricity and heat, and also produce water as a reaction byproduct.

When such a fuel cell system is driven in actual environments, such as cold start driving or rapid acceleration, flooding occurs at the cathode, so a back diffusion phenomenon in which water produced at the cathode side moves to the anode side may occur. In this case, when the water is not discharged well at the anode side or there is a problem with supply of hydrogen due to accumulation of water in the hydrogen supply route, a fuel starvation phenomenon occurs and the phenomenon of carbon corrosion in which carbon is oxidized instead of hydrogen may occur. Such carbon corrosion may cause reverse voltage at the anode and reduction of catalyst stability.

### SUMMARY

The present disclosure relates to a membrane-electrode assembly for preventing reverse voltage of a fuel cell. In more detail, the present disclosure relates preventing a reverse voltage phenomenon at an anode due to flooding that may occur in cold start driving or rapid acceleration driving by appropriately controlling physical property factors relating to the anode of a fuel cell.

An embodiment of the present disclosure can solve the problems described above and an embodiment of the present disclosure can provide a membrane-electrode assembly for preventing carbon corrosion and a reverse voltage phenomenon at an anode that may be generated in cold start driving or rapid acceleration driving by appropriately controlling physical property factors relating to the anode.

An embodiment of the present disclosure can provide a membrane-electrode assembly that does not influence the entire performance of fuel cells while preventing carbon corrosion and a reverse voltage phenomenon at an anode.

The advantages of embodiments of the present disclosure are not limited to the advantages described above. The advantages of embodiments of the present disclosure can be clearer from the following description and can be accomplished through the use and combinations thereof, as described in claims.

According to an embodiment of the present disclosure, a membrane-electrode assembly can prevent reverse voltage of a fuel cell, and the membrane-electrode assembly can include: a cathode; an anode positioned opposite to the cathode; and an electrolyte membrane positioned between the cathode and the anode, wherein the cathode and the anode each include a supported catalyst with a metal catalyst held on a support, and a ratio MC_{L}/R between metal catalyst loading MC_{L} in the anode and a supported metal catalyst ratio R is 0.125 to 0.3.

The metal catalyst may include at least one of platinum (Pt) or a platinum alloy (Pt-M), and the platinum alloy (Pt-M) may be an alloy of platinum (Pt) and any one metal (M) selected from a group of nickel (Ni), iron (Fe), cobalt (Co), chromium (Cr), manganese (Mn), tin (Sn), palladium (Pd), iridium (Ir), ruthenium (Ru), or any combination thereof.

In this example, when platinum (Pt) is used as the metal catalyst of the cathode, the ratio MC_{L}/R may be 0.125 to 0.3.

When a platinum alloy (Pt-M) is used as a metal catalyst of the cathode, the ratio MC_{L}/R may be 0.15 to 0.3.

In an embodiment, the support may include a carbon-based support.

In detail, the carbon-based support may include any one selected from a group of carbon black, carbon nanotubes, graphite, graphene, or any combination thereof.

In an embodiment, porosity of the anode may be 45% to 70%.

In an embodiment, a thickness of the anode may be 2.3 μm to 4.5 μm.

When platinum (Pt) is used as a metal catalyst of the cathode, a thickness of the anode may be 2.3 μm to 4.5 μm.

Further, when a platinum alloy (Pt-M) is used as a metal catalyst of the cathode, a thickness of the anode may be 3.4 μm to 4.5 μm.

In an embodiment, the anode may further include ionomer, and the ratio I_{L}/S_{L} of ionomer loading amount I_{L} in the anode and the support loading amount S_{L} may exceed 0.7 and may be less than 1.0.

According to an embodiment of the membrane-electrode assembly of the present disclosure, because the ratio MC_{L}/R between metal catalyst loading MC_{L} in an anode and a supported metal catalyst ratio R is within a predetermined numerical range, it can be possible to prevent deterioration of durability of a fuel cell due to flooding and reverse voltage at the anode.

Further, by adjusting porosity of the anode, the ratio I_{L}/S_{L} of ionomer loading amount I_{L} in the anode and the support loading amount S_{L}, and the thickness of the anode in appropriate ranges, it can be possible to prevent deterioration of durability of a fuel cell due to reverse voltage at the anode even without influencing the entire performance.

The advantages of embodiments of the present disclosure are not limited to the advantages described above. The advantages and embodiments of the present disclosure can be construed as including all those that can be inferred from the following description.

### BRIEF DESCRIPTION OF THE DRAWINGS

FIG. 1 schematically shows the structure of a fuel cell according to an embodiment of the present disclosure;

FIG. 2 proposes a flooding durability protocol according to experimental example if, using an embodiment of the present disclosure;

FIG. 3 shows the result of flooding durability verification according to the experimental example 1, using an embodiment of the present disclosure;

FIG. 4 shows the result of flooding durability verification for manufacturing examples 1 to 5, using an embodiment of the present disclosure;

FIG. 5 shows the result of flooding durability verification for manufacturing examples 6 to 12, using an embodiment of the present disclosure; and

FIG. 6 is the result of flooding durability verification for manufacturing examples 13 to 16, using an embodiment of the present disclosure.

### DETAILED DESCRIPTION OF ILLUSTRATIVE EMBODIMENTS

The above-mentioned features and advantages of embodiments the present disclosure, and other features and advantages, can be understood through the following example embodiments related to the accompanying drawings. However, the present disclosure is not limited to the example embodiments described herein and may be implemented by other ways. On the contrary, the example embodiments disclosed herein are provided so that the disclosed contents can be made through and complete, and the spirit of the present disclosure can be sufficiently transmitted to those skilled in the art.

Similar reference numerals can be assigned to similar components in the following description of drawings. In the accompanying drawings, the dimensions are structures can be exaggerated larger than the actual dimensions to make the present disclosure clear. Terms used in the specification, “first”, “second”, etc., may be used to describe various components, but the components are not to be construed as being necessarily limited by such terms. Such terms can be used merely to distinguish one component from another component. For example, the “first” component may be named the “second” component, and vice versa, without departing from the scopes of the present disclosure. Singular forms can be intended to include plural forms unless the context clearly indicates otherwise.

It can be understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof. When an element such as a layer, a film, a region, and a plate is “on” another component, it can be directly on the other element or intervening elements may be present therebetween. When an element such as a layer, a film, a region, and a plate is “beneath” another component, it can be directly beneath the other element or intervening elements may be present therebetween.

Unless stated otherwise, all the numerals, value, and/or expressions showing components, reaction conditions, and the amounts of polymer compositions and mixtures used herein are approximate quantities to which various uncertainties in measurement, which are generated when these numbers basically obtain these values from others, are reflected, so they should be construed as being modified by a term “approximately”. When a numeral range is disclosed herein, the range is continuous and includes all values from a minimum value to a maximum value including the maximum value in the range unless stated otherwise. When this range indicates an integer number, all integer values from a minimum value to a maximum value including the maximum value are included unless stated otherwise.

In the specification, when a range is described on the basis of variables, the variables can be understood as including all of the values in the specific range including the described end points of the range. For example, the range of “5 to 10” can be understood as including not only values of 5, 6, 7, 8, 9, and 10, but any lower ranges such as 6 to 10, 7 to 10, 6 to 9, and 7 to 9, and also can include arbitrary values between reasonable integers within the category of the specific range such as 5.5, 6.5, 7.5, 5.5 to 8.5, and 6.5 to 9. For example, the range of 10% to 30%” can be understood as including not only all of integers including values of 10%, 11%, 12%, 13%, etc. and even 30%, but any lower ranges such as 10% to 15%, 12% to 18%, and 20% to 30%, and also can include arbitrary values between reasonable integers within the category of the specific range such as 10.5%, 15.5%, and 25.5%.

In general, polymer electrolyte membrane fuel cells can be used in a stack type assembled by stacking tens of to hundreds of unit cells to satisfy the level of required power. The unit cells can include a bipolar plate, a gas diffusion layer (GDL), electrode layers (anode and cathode), and an electrolyte membrane, such as a proton exchange membrane, and the assembly formed by attaching the two electrodes to an electrolyte membrane can be called a Membrane Electrode Assembly (MEA). The configuration and performance of the MEA can be considered the core of fuel cells.

The bipolar plate, gas diffusion layer, electrode layers, and electrolyte membrane included in the fuel cells are not specifically limited in shape, thickness, area, or other features unless specifically defined and/or described in the specification, and those that are usually employed in the field of the present disclosure can be applied.

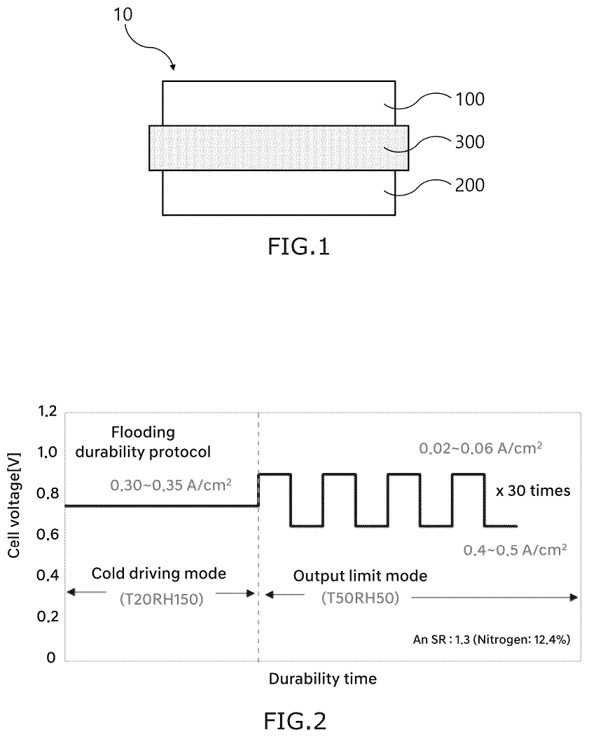

FIG. 1 schematically shows a membrane-electrode assembly according to an embodiment of the present disclosure. A membrane-electrode assembly 10 according to an embodiment of the present disclosure may include a cathode 200, an anode 100 disposed opposite to the cathode 200, and an electrolyte membrane 300 positioned between the cathode 200 and the anode 100.

The anode 100 can be an electrode receiving fuel such as hydrogen gas and separating the fuel into protons and electrons through a Hydrogen Oxidation Reaction (HOR), and can be also called a fuel electrode.

At the cathode 200, protons moving from the anode 100 through the electrolyte membrane 300 and electrons supplied from an external circuit oxygen gas can generate electricity and heat and produce water as a reaction byproduct through an Oxygen Reduction Reaction (ORR) with oxygen gas supplied from the outside.

The anode 100 and the cathode 200 each can include a metal catalyst for easy oxidation and reduction reactions at the anode 100 and the cathode 200. The metal catalyst may be provided as a supported catalyst with the metal catalyst deposited on a support.

The support can enhance the activity surface area of the metal catalyst and improve its stability by holding the metal catalyst on the surface.

In an embodiment, the metal catalyst can include at least one of platinum (Pt) and a platinum alloy (Pt-M) and the platinum alloy (Pt-M) may be an alloy of platinum (Pt) and any one metal (M) selected from a group of nickel (Ni), iron (Fe), cobalt (Co), chromium (Cr), manganese (Mn), tin (Sn), palladium (Pd), iridium (Ir), ruthenium (Ru), or any combination thereof.

Further, the support may include a carbon-based support. For example, the carbon-based support may include any one selected from a group of carbon black, carbon nanotubes, graphite, graphene, or any combination thereof.

When a fuel cell is driven under a cold driving condition such as room temperature and high humidity or under an output-limiting condition that alternates between high and low current densities, water can be produced at the cathode 200 and can be difficult to discharge outside, so a flooding phenomenon may occur at the cathode 200. When water moving to the anode 100 from the cathode 200 clogs up pores in the anode 100 due to flooding and back diffusion at the cathode 200, it may interfere with activation of the metal catalyst on the surface of the support.

In this case, the water can block hydrogen that is supplied to the metal catalyst, so the HOR may be difficult to occur. In this case, overpotential of the cathode 200 can increase, a current can be generated due an oxidation reaction of carbon that is used as a support, and reverse voltage or carbon corrosion phenomenon may be generated.

To prevent such reverse voltage or carbon corrosion phenomenon due to flooding, it may be effective to increase the time it takes for an electrode to submerge in water. As methods of increasing the time, there may be a method of increasing the increase of the area of a metal catalyst that needs to be covered by water by increasing the loading amount of the metal catalyst in an electrode or a method of widely distributing a metal catalyst in an electrode by decreasing the ratio of the metal catalyst that is held on a support.

In the membrane-electrode assembly 10 according to an embodiment of the present disclosure, the ratio (MC_{L}/R) of metal catalyst loading “MC_{L}” in the anode 100 and a supported metal catalyst ratio “R” may be 0.125 to 0.3. The “metal catalyst loading MC_{L}” can be understood as the content per area (mg/cm²) of a metal catalyst included in the anode 100. The “supported metal catalyst ratio R” can be understood as the ratio of the mass of a metal catalyst held in a supported catalyst to the entire mass of the supported catalyst.

For example, when the mass of a supported catalyst (Pt/C) with a platinum catalyst held on a carbon support is 10 g, and the mass of a carbon support is 6.5 g and the mass of a platinum catalyst is 3.5 g in 10 g of the supported catalyst, the supported metal catalyst ratio R can be calculated as 35% and/or 0.35.

When the ratio MC_{L}/R exceeds 0.3, the thickness of the anode 100 excessively increases (e.g., exceeding 4.5 μm to 5 μm), and the ionic conductivity may greatly decrease. When the ionic conductivity of the anode 100 decreases, there can be a risk of performance degradation of the entire fuel cell.

When the ratio MC_{L}/R is lower than 0.125 or 0.15, an anode can be submerged by water moved by back diffusion under an extreme flooding condition, whereby hydrogen supply may become difficult. Accordingly, the voltage of the anode 100 may drop, or, if severe, reverse voltage may be generated. In this case, whether the ratio MC_{L}/R that causes the voltage drop phenomenon and/or the reverse voltage phenomenon is less than 0.125 or less than 0.15 can be determined by the shape and kind of the metal catalyst in the cathode 200.

For example, when platinum (Pt) is used as the metal catalyst of the cathode 200, the ratio MC_{L}/R may be 0.125 to 0.3. For example, when a platinum alloy (Pt-M) is used as the metal catalyst of the cathode 200, the ratio MC_{L}/R may be 0.15 to 0.3.

When a platinum alloy (Pt-M) is used as the metal catalyst of the cathode 200, hydrophilicity can increase and this may be disadvantageous in discharge of waver, as compared with when only platinum is used. Accordingly, to suppress reverse voltage due to flooding, it may be possible to increase the lower limit value of the ratio MC_{L}/R (e.g., by 0.15 or more) or, as will be described below, it can be possible to increase the thickness of an anode.

In the membrane-electrode assembly 10 according to an embodiment of the present disclosure, it can be possible to delay the time it takes for the anode 100 to submerge in the water moved by back diffusion by adjusting the ratio MC_{L}/R, which can be the thickness of an electrode and the density of platinum per unit thickness, to the range of 0.125 to 0.3.

In particular, because it can be possible to suppress degradation of the ionic conductivity of the anode 100, it can be possible to prevent reverse voltage without influencing the entire performance of the fuel cell.

In an embodiment, the anode 100 may have a porous structure, and in such case, the porosity of the anode 100 may be 45% to 99%. Preferably, the porosity may be 45% to 70%. When the porosity of the anode 100 is less than 45%, the problem that hydrogen supply is interfered with by flooding at the anode 100 can be generated, and the fuel cell may become vulnerable to reverse voltage. In such case, the method of measuring the pores of the anode 100 is not specifically limited, and a mercury intrusion method, a BET measurement method, and/or the like well-known in the art, may be used.

In the membrane-electrode assembly 10 according to an embodiment of the present disclosure, it can be possible to reduce the ratio of the anode 100 submerged in water moved by back diffusion by adjusting the thickness of the anode 100. In more detail, the thickness of the anode 100 may be 2.3 μm to 4.5 μm, for example. When the thickness of the anode 100 exceeds 4.5 μm, the performance of the fuel cell may be deteriorated due to reduction of the ionic conductivity of the anode 100. When the thickness of the anode 100 is less than 2.3 μm, the ratio of the anode 100 submerged in water can increase, so it may be difficult to prevent reverse voltage.

For example, when platinum (Pt) is used as the metal catalyst of the cathode 200, the thickness of the anode 100 may be 2.3 μm to 4.5 μm, and when a platinum alloy (Pt-M) is used as the metal catalyst of the cathode 200, the thickness of the anode 100 may be 3.4 μm to 4.5 μm.

When a platinum alloy (Pt-M) is used as the metal catalyst of the cathode 200, hydrophilicity can increase and this may be disadvantageous in discharge of waver, as compared with when only platinum is used. Accordingly, to suppress reverse voltage due to flooding, it can be possible to increase the thickness of the anode 100 (e.g., 3.4 μm or more) or increase the lower limit value of the ratio MC_{L}/R.

In an embodiment, the anode 100 may further include an ionomer. The ionomer, which can be a component included in the anode, providing proton ion conductivity, and functioning as a binder, can be used without specific limitation as long as it is generally used in the art. For example, the ionomer may include a perfluorosulfonic compound and/or a hydrocarbon-based polymer.

As the perfluorosulfonic compound, there are “Nafion” (registered trademark) by DuPont, “Flemion” (registered trademark) by AGC Inc., “Aciplex” (registered trademark) by AGC Inc., “GORE-SELECT” (registered trademark) by Gore, etc., for example.

Further, the hydrocarbon-based polymer can be a polymer that imparts proton conductivity to a hydrocarbon backbone, and for example, there are polysulfone, Polyethersulfone, Polyphenylene oxide, a Polyarylene ether polymer, Polyphenylene sulfide, Polyphenylene sulfide sulfone, Polyparaphenylene, a Polyarylene polymer, Polyarylene ketone, Polyether ketone, Polyarylene phosphine oxide, Polyether phosphine oxide, Polybenzoxazole, Polybenzenethiazole, Polybenzimidazole, Aromatic polyamide, Polyimide, Polyetherimide, Polyimidesulfon, or a similar polymer as would be known in the art.

In an embodiment, the ratio I_{L}/S_{L} of ionomer loading I_{L} in the anode 100 and the support loading S_{L} may exceed 0.7 and may be less than 1.0. Preferably, the ratio may exceed 0.7 and 0.85 or less. In such case, the “ionomer loading I_{L}” in the anode 100 can be the content per unit area mg/cm² of ionomer included in the anode 100 and the “support loading S_{L}.” may be the content per area mg/cm² of the support, particularly, the carbon-based support included in the anode 100.

When the ratio I_{L}/S_{L} is 0.7 or less, the ionomer loading in the anode can be small, so the initial performance of the membrane-electrode assembly may be deteriorated. In general, because ionomer in an electrode can have the property of absorbing water, when the ratio I_{L}/S_{L} is 1 or more, ionomer may attract water and block the pores in the anode 100. In such case, the anode 100 may become vulnerable to flooding, reverser voltage, and/or carbon corrosion.

When the ratio exceeds 0.7 and is 0.85 or less, the initial performance and flooding durability of the membrane-electrode assembly can be excellent on balance.

Further, the anode 100 may further include a water-repellent agent, such as polytetrafluoroethylene (PTFE). The water-repellent agent can help prevent flooding at the anode 100.

An embodiment of the present disclosure can provide, as physical property factors that influence prevention of the phenomenon of flooding, carbon corrosion, and reverse voltage that may occur at an electrode, particularly, the anode 100 of the membrane-electrode assembly 10 of the present disclosure, 1) the ratio MC_{L}/R of the metal catalyst loading MC_{L} in the anode 100 and supported metal catalyst ratio R, 2) the porosity of the anode 100, 3) the ratio I_{L}/S_{L} of the ionomer loading I_{L} and the support loading S in the anode 100, and 4) the thickness of the anode 100.

An embodiment of the present disclosure can prevent deterioration of a fuel cell due to reverse voltage at the anode 100 even without influencing the entire performance of the fuel cell using the physical property factors.

The physical property factors can be understood as being organically connected to each other in that they can be related to increasing a space that needs to be filled with water to delay the time it takes for water to block the pores of the anode 100 when the water flows into the anode 100 and to widely distributing a metal catalyst that needs to be covered by the water.

The membrane-electrode assembly 10 according to an embodiment of the present disclosure may be included in a transportation system. The transportation system may refer to a system that is used to transport objects, people, or other things. The transportation system, for example, includes a land transportation systems, a maritime transportation systems, and an aerial transportation systems. The land transportation systems may include, for example, vehicles including a passenger car, a van, a truck, a trailer truck, and a sports car, a bicycle, a motorcycle, a train, or other vehicle. The maritime transportation systems, for example, may include a ship, a submarine, or other water-travel vehicle. The aerial transportation systems may include, for example, an airplane, a hang glider, a hot air balloon, a helicopter, and a small flying vehicle such as a drone.

Hereafter, the present disclosure is described in detail with reference to the following example embodiments and comparative examples. However, the technical spirit of the present disclosure is not necessarily limited by them.

### Manufacturing Example 1˜ Manufacturing Example 12

An electrolyte membrane was obtained by applying perfluorosulfonic ionomer dispersion (Nafion® D2021 Dispersion, DuPont, USA) to a release paper, drying it, and then removing the release paper.

A supported catalyst (Pt/C) with a platinum catalyst held on carbon black that is a carbon support was prepared. In this case, the ratio R of the platinum catalyst held on the carbon support was 15% (0.15), 20% (0.2), 25% (0.25), 35% (0.35), and 50% (0.5), as shown in the following Table 1.

Cathode catalyst slurry was made by introducing the prepared supported catalyst into methanol together with perfluorosulfonic ionomer. Further, anode catalyst slurry was made by introducing the prepared supported catalyst into methanol together with perfluorosulfonic ionomer to have predetermined ratios I_{L}/S_{L}, as shown in the following Table 1.

A membrane-electrode assembly with an electrolyte membrane between a cathode and an anode was manufactured by applying the cathode catalyst slurry and the anode catalyst slurry to a first surface and a second surface of the electrolyte membrane, respectively, and then drying them. Thereafter, heat treatment was performed on the membrane-electrode assembly at about 180° C. for 5 minutes, thereby achieving membrane-electrode assemblies according to the manufacturing example 1 to the manufacturing example 12 satisfying the physical property factors described in the following Table 1.

The ratio MC_{L}/R of the metal catalyst loading MC_{L} and the supported metal catalyst ratio R in the anodes included in the membrane-electrode assemblies according to the manufacturing example 1 to the manufacturing example 12, the porosity of the anodes, the ratio I_{L}/S_{L} of the ionomer loading I_{L} and the support loading S_{L} in the anodes, and the thickness of the anodes are as in the following Table 1.

TABLE 1

| | Manufacturing example | | | | | | | | | | | |
|---|---|---|---|---|---|---|---|---|---|---|---|---|
| Items | 1 | 2 | 3 | 4 | 5 | 6 | 7 | 8 | 9 | 10 | 11 | 12 |
| R | 15% | | | 20% | | | 25% | | 35% | | | 50% |
| MC_{L} | 0.02 | 0.03 | 0.05 | 0.02 | 0.025 | 0.03 | 0.02 | 0.03 | 0.03 | 0.05 | 0.08 | 0.05 |
| (mg/cm²) | | | | | | | | | | | | |
| Thickness | 3.0 | 4.4 | 6.7 | 2.1 | 2.8 | 3.4 | 1.8 | 2.5 | 1.4 | 2.3 | 3.4 | 1.3 |
| (μm) | | | | | | | | | | | | |
| Ratio | 0.133 | 0.2 | 0.33 | 0.1 | 0.125 | 0.15 | 0.08 | 0.12 | 0.086 | 0.143 | 0.228 | 0.1 |
| (MC_{L}/R) | | | | | | | | | | | | |
| Porosity | 0.61 | 0.64 | 0.64 | 0.45 | 0.52 | 0.56 | 0.41 | 0.48 | 0.4 | 0.51 | 0.57 | 0.38 |
| I_{L}/S_{L} | 0.8 | 0.8 | 0.8 | 0.8 | 0.8 | 0.8 | 0.8 | 0.8 | 0.8 | 0.8 | 0.8 | 0.8 |

### Experimental Example 1-Verification of Reverse Voltage Robustness Under Condition Vulnerable to Flooding

To verify the reverse voltage robustness in the anode of the membrane-electrode assembly according to an embodiment of the present disclosure, a flooding durability protocol was conducted a total of two times for the manufacturing example 9 to the manufacturing example 12 having the supported metal catalyst ratio R of 35% and 50% under the conditions of the following Table 2 and FIG. 2. The fuel that was supplied to the anodes was supplied by partially mixing nitrogen into hydrogen, as in the following Table 2.

TABLE 2

| | Operation conditions | | | |
|---|---|---|---|---|
| | | | | An. |
| | | | | stoichiometric |
| Verifi- | Temper- | Relative | | ratio |
| cation | ature | humidity | | (SR; nitrogen |
| mode | (° C.) | (%) | Current | %) |
| Cold | 20 | 150 | 80~90 A (0.3~0.35 | 1.3 |
| driving | | | A/cm²) | (12.4%) |
| Output | 50 | 50 | 10.5~11 A [symbol] 115~125 | 1.3 |
| limit | | | A repeated | (12.4%) |
| | | | (0.02~0.06 | |
| | | | A/cm² [symbol] 0.4~0.5 | |
| | | | A/cm²) | |

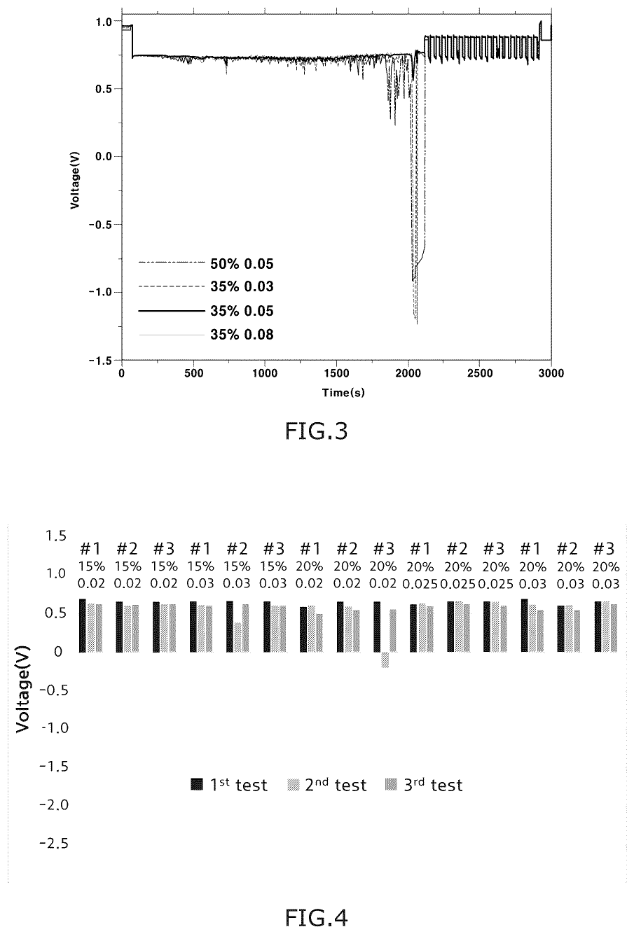

The results of flooding durability protocol for the manufacturing example 9 to the manufacturing example 12 are shown in FIG. 3, and the maximum cell voltage difference Vmax and whether there was reverse voltage RV are shown in Table 3 on the basis of FIG. 3.

TABLE 3

| | | Manufacturing | | | Manufacturing | | | Manufacturing | | | Manufacturing | | |
|---|---|---|---|---|---|---|---|---|---|---|---|---|---|
| | Verification | example 9 | | | example 10 | | | example 11 | | | example 12 | | |
| Items | mode | ΔVmax | | RV | ΔVmax | | RV | ΔVmax | | RV | ΔVmax | | RV |
| First | Cold | 1.98 | V | ◯ | 41 | mV | X | 77 | mV | X | 1.71 | V | ◯ |
| round | driving | | | | | | | | | | | | |
| | Output | 190 | mV | X | 190 | mV | X | 236 | mV | X | 1.85 | V | ◯ |
| | limit | | | | | | | | | | | | |
| Second | Cold | 1.88 | V | ◯ | 36 | mV | X | 35 | mV | X | 1.61 | V | ◯ |
| round | driving | | | | | | | | | | | | |
| | Output | 2.11 | V | ◯ | 195 | mV | X | 168 | mV | X | 180 | mV | X |
| | limit | | | | | | | | | | | | |

Referring to the result of Table 3, no reverse voltage was observed in the manufacturing example 10 and the manufacturing example 11 that satisfy all of physical property values according to the present disclosure.

### Experimental Example 2-Verification of Reverse Voltage Robustness Under Various Conditions

To verify the reverse voltage robustness in an anode under more various conditions, a flooding durability protocol was conducted a total of three times for the membrane-electrode assemblies of the manufacturing example 1 to the manufacturing example 12 under the same conditions as the experimental example 1. Further, to increase the reliability of the result, three same samples (#1, #2, #3) were made for each manufacturing example, and when voltage decreased or reverse voltage was generated even in any one sample, as the following conditions, the durability result in the corresponding round was determined as “poor”.

In detail, when the flooding durability result voltage was 0.25V or more, it was determined as “good”, and when it is-0.02V or more and less than 0.25V, it was determined as “poor (voltage 1)”, and when it is less than-0.02V, it was determined as “poor (reverse voltage)”.

The results of flooding durability protocol for the manufacturing example 1 to the manufacturing example 12 are shown in FIGS. 4 and 5, and flooding durability results based on FIGS. 4 and 5 are shown in the following Table 4. Further, the initial performance of the membrane-electrode assemblies according to the manufacturing example 1 to the manufacturing example 12 and the initial performance difference from the manufacturing example 12 are shown in Table 4.

TABLE 4

| | | Manufacturing examples | | | | | | | | | | | |
|---|---|---|---|---|---|---|---|---|---|---|---|---|---|
| Items | | 1 | 2 | 3 | 4 | 5 | 6 | 7 | 8 | 9 | 10 | 11 | 12 |
| Initial | | 99% | 99% | 95% | 100% | 101% | 100% | 102% | 101% | 100% | 100% | 99% | 100% |
| performance | | | | | | | | | | | | | |
| @ 2 A/cm², | | | | | | | | | | | | | |
| 2.5 bar | | | | | | | | | | | | | |
| Flooding | Round 1 | Good | Good | Good | Good | Good | Good | Poor | Poor | Poor | Good | Good | Poor |
| durability | | | | | | | | (reverse | (voltage ↓) | (reverse | | | (reverse |
| | | | | | | | | voltage) | | voltage) | | | voltage) |
| | Round 2 | Good | Good | Good | Poor | Good | Good | Good | Poor | Good | Good | Good | Poor |
| | | | | | (voltage ↓) | | | | (voltage ↓) | | | | (reverse |
| | | | | | | | | | | | | | voltage) |
| | Round 3 | Good | Good | Good | Good | Good | Good | Poor | Good | Poor | Good | Good | Poor |
| | | | | | | | | (reverse | | (reverse | | | (reverse |
| | | | | | | | | voltage) | | voltage) | | | voltage) |

Referring to the results of Table 4, the initial performance of the cells was excellent and no reverse voltage was observed in the manufacturing example 1, manufacturing example 2, manufacturing example 5, manufacturing example 6, manufacturing example 10, and manufacturing example 11 that satisfy all of the physical property factors according to an embodiment of the present disclosure.

In the case of manufacturing example 3 in which the ratio MC_{L}/R of the physical property factors according to an embodiment of the present disclosure exceeds 0.3, it was found out that the flooding durability performance was good, but the initial performance of the fuel cell decreased.

Further, in the case of manufacturing 8 in which the ratio MC_{L}/R of the physical property factors according to an embodiment of the present disclosure is less than the minimum value of a numerical range proposed in the present disclosure and in the case of manufacturing 4 in which the ratio MC_{L}/R and the thickness of the anode are both less than minimum values, the flooding durability test result voltage decreased. Further, in the manufacturing example 7, manufacturing example 9, and manufacturing example 12 in which the ratio MC_{L}/R of the physical property factors according to an embodiment of the present disclosure, the anode thickness, and the porosity of the anode were all less than minimum values, reverse voltage was observed as the result of flooding durability test.

### Experimental Example 3-Flooding Evaluation of Ratio I_{L}/S_{L} of Ionomer Loading I_{L} and Support Loading Si in Anode

To check flooding information according to the ratio I_{L}/S_{L} of ionomer loading I_{L} and support loading S_{L} in an anode, membrane-electrode assemblies according to the manufacturing example 13 to the manufacturing example 16 were manufactured in the same way as the manufacturing examples described above, and the detailed specifications were set as in the following Table 5.

Thereafter, a flooding durability protocol was conducted a total of three times to these manufacturing examples under the same conditions as in the experimental example 1. The evaluation criteria for good and poor is the same as that described above in the experimental example 2.

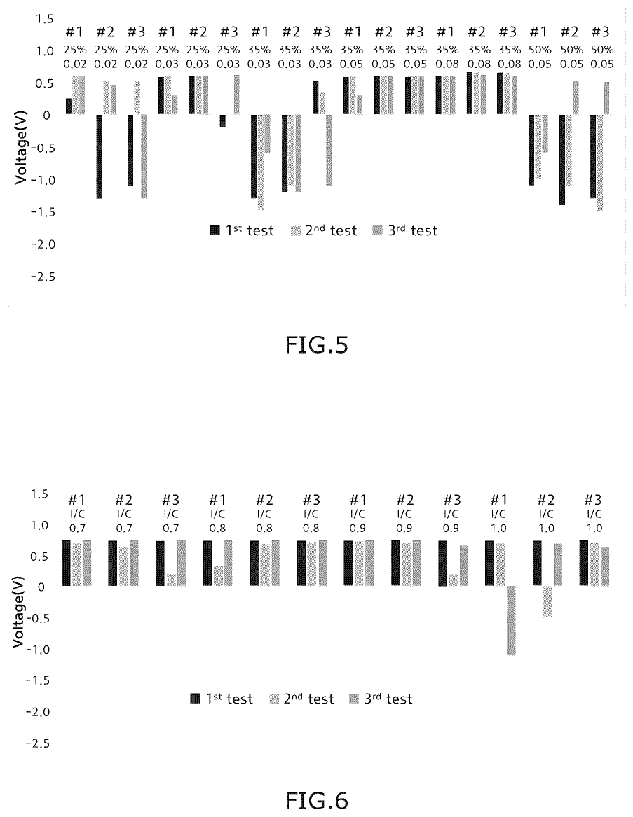

The results of flooding durable protocol for the manufacturing example 13 to the manufacturing example 16 are shown in FIG. 6 and the flooding durability results based on FIG. 6 are shown in the following Table 5. Further, the initial performance of the membrane-electrode assemblies according to the manufacturing example 13 to the manufacturing example 16 and the initial performance difference from the manufacturing example 12 are shown in Table 5.

TABLE 5

| | | Manufacturing examples | | | |
|---|---|---|---|---|---|
| Items | | 13 | 14 | 15 | 16 |
| Ratio (I_{L}/S_{L}) | | 0.7 | 0.8 | 0.9 | 1.0 |
| MC_{L}(mg/cm²) | | 0.05 | | | |
| Ratio (MC_{L}/R) | | 0.143 | | | |
| Porosity | | 0.51 | | | |
| Initial | | 95% | 100% | 101% | 99% |
| performance | | | | | |
| @ 2 A/cm², | | | | | |
| 2.5 bar | | | | | |
| Flooding | Round | Good | Good | Good | Good |
| durability | 1 | | | | |
| | Round | Poor | Good | Poor | Poor |
| | 2 | (voltage ↓) | | (voltage ↓) | (reverse |
| | | | | | voltage) |
| | Round | Good | Good | Good | Poor |
| | 3 | | | | (reverse |
| | | | | | voltage) |

Referring to the result of Table 5, when the ratio I_{L}/S_{L} was 0.9 or less, only the phenomenon of small reduction of voltage was observed and reverse voltage was not generated. Further, when the ratio I_{L}/S_{L} was 0.7, the phenomenon of reduction of the initial performance was observed in the flooding durability result.

In the manufacturing example 14 and manufacturing example 15 that satisfy the condition that the ratio I_{L}/S_{L} exceeds 0.7 and is less than 1.0, the initial performance was excellent and the flooding durability result was also determined as good except for a voltage drop in some rounds. In particular, the manufacturing example 14 in which the ratio I_{L}/S_{L} exceeds 0.7 and is less than 0.85 was determined as good in all rounds.

It was found out from the above experiment results that it is possible to prevent deterioration of the performance of a fuel cell and suppress the phenomenon of flooding, carbon corrosion, and reverse voltage when all of the predetermined numerical ranges about the conditions related to the physical property factors proposed in an embodiment of the present disclosure, the ratio MC_{L}/R of the metal catalyst loading MC_{L} and the supported metal catalyst ratio R, the porosity of an anode, the ratio (I_{L}/S_{L} of the ionomer loading I_{L} and the support loading Su in an anode, and the thickness of an anode are satisfied.

Although example embodiments of the present disclosure were described above, those skilled in the art may change and modify an embodiment of the present disclosure in various ways by adding, changing, or removing components without departing from the spirit of the present disclosure described in claims, which can be understood as being included in the scopes of the present disclosure.

What is claimed is:

1. A membrane-electrode assembly comprising:
a cathode;
an anode positioned opposite to the cathode; and
an electrolyte membrane positioned between the cathode and the anode,
wherein the cathode and the anode each comprises a supported catalyst with a metal catalyst held on a support, and
wherein a ratio MC_{L}/R between metal catalyst loading MC_{L} in the anode and a supported metal catalyst ratio R is in a first range of 0.125 to 0.3.

2. The membrane-electrode assembly of claim 1, wherein the metal catalyst comprises at least one of platinum (Pt) or a platinum alloy (Pt-M), and
wherein the platinum alloy (Pt-M) is an alloy of platinum (Pt) and any one metal (M) selected from a group of nickel (Ni), iron (Fe), cobalt (Co), chromium (Cr), manganese (Mn), tin (Sn), palladium (Pd), iridium (Ir), ruthenium (Ru), or any combination thereof.

3. The membrane-electrode assembly of claim 2, wherein platinum (Pt) is used as a metal catalyst of the cathode and the ratio MC_{L}/R is 0.125 to 0.3.

4. The membrane-electrode assembly of claim 2, wherein a platinum alloy (Pt-M) is used as a metal catalyst of the cathode and the ratio MC_{L}/R is 0.15 to 0.3.

5. The membrane-electrode assembly of claim 1, wherein the support comprises a carbon-based support.

6. The membrane-electrode assembly of claim 5, wherein the carbon-based support comprises any one selected from a group of carbon black, carbon nanotubes, graphite, graphene, or any combination thereof.

7. The membrane-electrode assembly of claim 1, wherein porosity of the anode is in a porosity range of 45% to 70%.

8. The membrane-electrode assembly of claim 1, wherein an anode thickness of the anode is in a first thickness range of 2.3 μm to 4.5 μm.

9. The membrane-electrode assembly of claim 2, wherein an anode thickness of the anode is in a first thickness range of 2.3 μm to 4.5 μm if the metal catalyst of the cathode is platinum (Pt).

10. The membrane-electrode assembly of claim 2, wherein an anode thickness of the anode is in a second thickness range of 3.4 μm to 4.5 μm if the metal catalyst of the cathode is the platinum alloy (Pt-M).

11. The membrane-electrode assembly of claim 1, wherein the anode further comprises ionomer, wherein a ratio I_{L}/S_{L} of ionomer loading amount I_{L} in the anode and a support loading amount S_{L} exceeds 0.7 and is less than 1.0.

12. A membrane-electrode assembly comprising:
a cathode;
an anode positioned opposite to the cathode; and
an electrolyte membrane positioned between the cathode and the anode,
wherein the cathode and the anode each comprises a supported catalyst with a metal catalyst held on a support,
wherein the metal catalyst comprises platinum (Pt) or a platinum alloy (Pt-M),
wherein the platinum alloy (Pt-M) comprises an alloy of platinum (Pt) and any one metal (M) selected from a group of nickel (Ni), iron (Fe), cobalt (Co), chromium (Cr), manganese (Mn), tin (Sn), palladium (Pd), iridium (Ir), ruthenium (Ru), or any combination thereof,
wherein a ratio MC_{L}/R between metal catalyst loading MC_{L} in the anode and a supported metal catalyst ratio R is in a first range of 0.125 to 0.3 when the metal catalyst of the cathode is platinum (Pt), and
wherein the ratio MC_{L}/R is in a second range of 0.15 to 0.3 when the metal catalyst of the cathode is the platinum alloy (Pt-M).

13. The membrane-electrode assembly of claim 12, wherein the support comprises a carbon-based support.

14. The membrane-electrode assembly of claim 13, wherein the carbon-based support comprises carbon black, carbon nanotubes, graphite, graphene, or any combination thereof.

15. The membrane-electrode assembly of claim 12, wherein porosity of the anode is in a porosity range of 45% to 70%.

16. The membrane-electrode assembly of claim 12, wherein an anode thickness of the anode is in a first thickness range of 2.3 μm to 4.5 μm if the metal catalyst of the cathode is platinum (Pt).

17. The membrane-electrode assembly of claim 12, wherein an anode thickness of the anode is in a second thickness range of 3.4 μm to 4.5 μm if the metal catalyst of the cathode is the platinum alloy (Pt-M).

18. The membrane-electrode assembly of claim 12, wherein the anode further comprises ionomer, wherein a ratio I_{L}/S_{L} of ionomer loading amount I_{L} in the anode and a support loading amount S_{L} exceeds 0.7 and is less than 1.0.

19. A membrane-electrode assembly comprising:
a cathode;
an anode positioned opposite to the cathode; and
an electrolyte membrane positioned between the cathode and the anode,
wherein the cathode and the anode each comprises a supported catalyst with a metal catalyst held on a support,
wherein a ratio MC_{L}/R between metal catalyst loading MC_{L} in the anode and a supported metal catalyst ratio R is in a first range of 0.125 to 0.3,
wherein porosity of the anode is in a porosity range of 45% to 70%, and
wherein the anode further comprises ionomer, wherein a ratio I_{L}/S_{L} of ionomer loading amount I_{L} in the anode and a support loading amount S_{L} exceeds 0.7 and is less than 1.0.

20. The membrane-electrode assembly of claim 19, wherein the support comprises a carbon-based support, and wherein the carbon-based support comprises any one selected from a group of carbon black, carbon nanotubes, graphite, graphene, or any combination thereof.
